(19) United States
(12) Patent Application Publication
(10) Pub. No.: US 2024/0114889 A1
(43) Pub. Date: Apr. 11, 2024

(54) PEST CONTROL DEVICES AND METHODS RELATED TO ASSEMBLING THE SAME

(71) Applicant: VM Products, Inc., Bedford, TX (US)

(72) Inventor: Ethan VICKERY, Arlington, TX (US)

(73) Assignee: VM Products, Inc., Bedford, TX (US)

(21) Appl. No.: 18/481,837

(22) Filed: Oct. 5, 2023

Related U.S. Application Data
(60) Provisional application No. 63/413,917, filed on Oct. 6, 2022.

(51) Int. Cl. A01M 23/00

(52) U.S. Cl. CPC A01M 23/005

(57) ABSTRACT

A pest control device is disclosed. The pest control device includes a base and a lid. The base includes an opening. The lid is attached to the base and pivotable between a first position and a second position. The lid includes a ramp. When the lid is in the first position: (i) the base and the lid define an interior volume and (ii) the ramp is adjacent the opening of the base. The disclosed pest control device more effectively traps a pest with an adhesive material and facilitate replacement of a used adhesive material.

### CROSS-REFERENCE TO RELATED APPLICATIONS

This application claims the benefit of priority to U.S. Provisional Patent Application Ser. No. 63/413,917, filed Oct. 6, 2022, which application is hereby incorporated by reference in its entirety.

### FIELD OF INVENTION

The present invention relates generally to pest control devices, and, more particularly, to improved pest control devices and methods related to assembling the same.

### BACKGROUND

Devices for capturing animals, including pests such as rodents, have been in use for many years. Traditional “glue traps” work through trapping the rodent on an adhesive material. The rodent may be lured onto the adhesive material with bait. Some rodents, however, are capable of escaping from glue traps.

For these and other reasons, a need exists for more effective pest capture devices.

### SUMMARY

New and innovative pest control devices are provided that more effectively trap pests with an adhesive material. For example, embodiments of the provided pest control devices include at least one ramp that make it more likely a pest will commit to contacting the adhesive material and thereby become trapped on the adhesive material. The provided pest control devices can also facilitate unobstructed replacement of used adhesive material.

In an example, a pest capture device, includes a base and a lid attached to the base and pivotable between a first position and a second position. The base includes an opening. The lid includes a ramp. When the lid is in the first position: (i) the base and the lid define an interior volume and (ii) the ramp is adjacent the opening of the base.

In another example, pest capture device includes a base, a lid pivotably attached to the base, and an adhesive material positioned between a floor of the base and the lid. The base includes a plurality of sides and the floor. A first side of the base includes a first opening and a second side of the base includes a second opening. The lid includes a first ramp and a second ramp. The first ramp includes a first end opposite a second end, wherein the first end is adjacent the first opening of the base, wherein the second end is spaced from the first opening of the base, and wherein the second end is spaced farther from the bottom of the base than the first end. The second ramp includes a third end opposite a fourth end, wherein the third end is adjacent the second opening of the base, wherein the fourth end is spaced from the second opening of the base, and wherein the fourth end is spaced farther from the bottom of the base than the third end.

In another example still, a method is provided for replacing an adhesive plate within an interior volume of a pest capture device, the pest capture device including a base and a lid, the base including an opening, the lid including a ramp, and the ramp being adjacent the opening of the base when the lid is in a first position. The method includes pivoting the lid from the first position to a second position thereby exposing the interior volume of the pest capture device. The adhesive plate is then removed from the interior volume. A new adhesive plate is then inserted into the interior volume.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Further, a device or system that is configured in a certain way is configured in at least that way, but it can also be configured in other ways than those specifically described.

Some details associated with the embodiments described above and others are described below.

### BRIEF DESCRIPTION OF THE DRAWINGS

FIG. 1 depicts a first perspective view of one embodiment of the present pest capture devices, shown in an closed position.

FIG. 2 depicts a second perspective view of the pest capture device of FIG. 1 in the closed position.

FIG. 3 depicts a top view of the pest capture device of FIG. 1, shown in an open position with the interior sides of the lid and base visible and with one of the ramps removed from the lid and disposed on the base.

FIG. 4 depicts a side view of the pest capture device of FIG. 1 in the closed position.

FIG. 5 depicts a cross sectional view of the pest capture device of FIG. 1 along the plane 5-5 in FIG. 1.

FIG. 6 depicts a cross sectional view of the pest capture device of FIG. 1 along the plane 6-6 in FIG. 1.

FIG. 7 depicts a first exploded view of the pest capture device of FIG. 1.

FIG. 8 depicts a second exploded view of the pest capture device of FIG. 1.

FIG. 9 depicts a partially exploded view of the pest capture device of FIG. 1, shown with the top portion separated from the bottom portion.

FIG. 10 depicts a perspective view of the pest capture device of FIG. 1, shown in an open position with the lid separated from the base.

### DETAILED DESCRIPTION OF ILLUSTRATIVE EMBODIMENTS

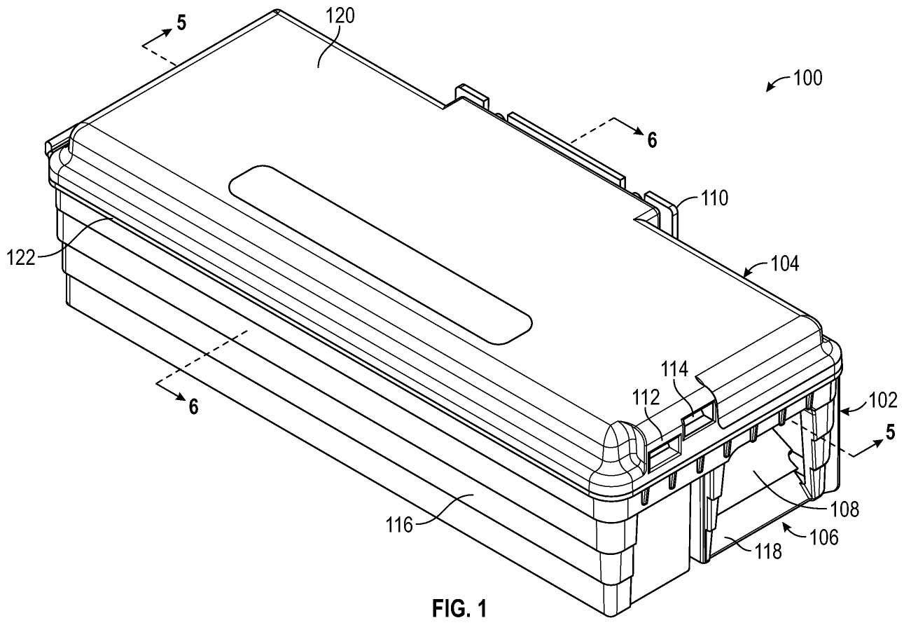

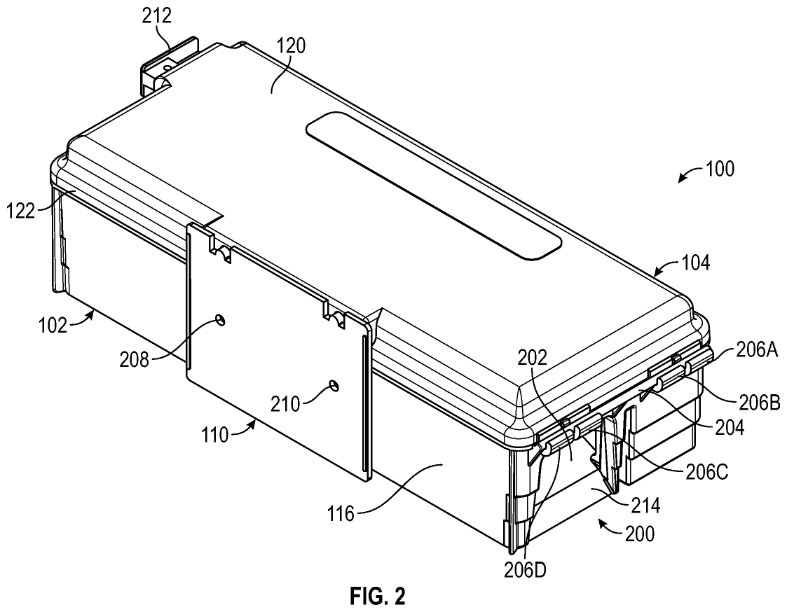

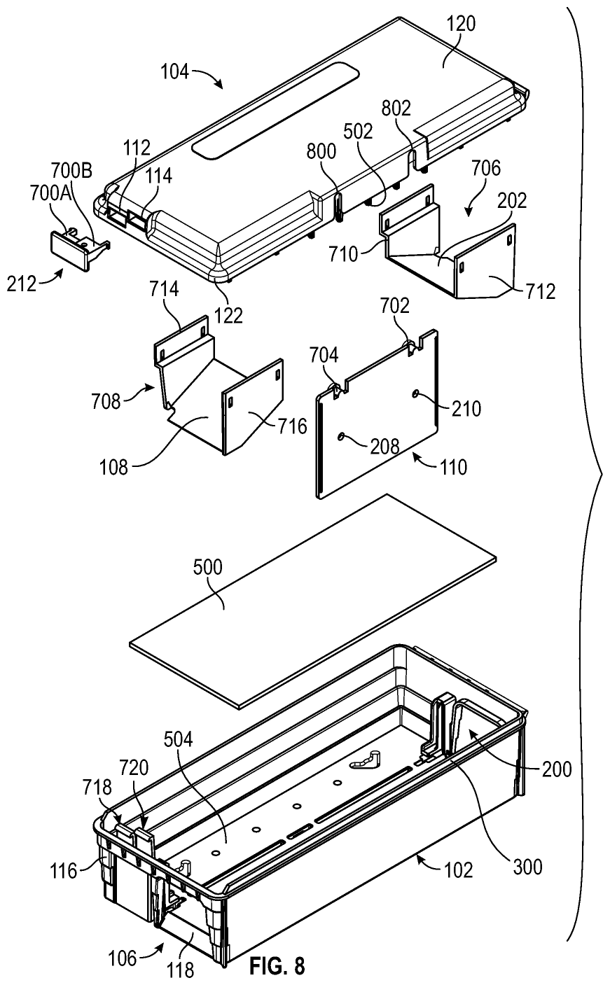

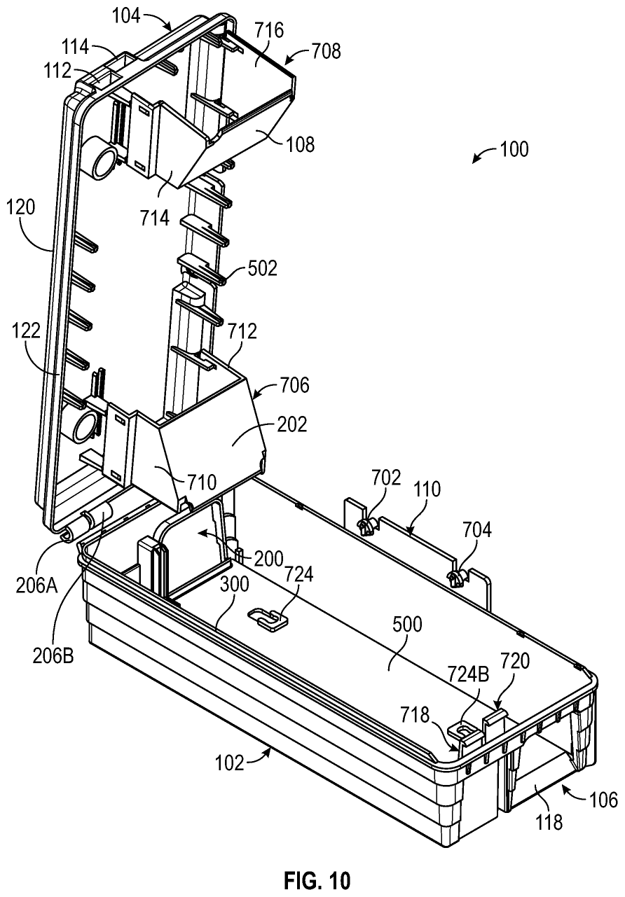

Referring now to the drawings, and more particularly to FIGS. 1-10, shown therein and designated by reference numeral 100 is an exemplary embodiment of the present pest control devices. Device 100 may be used to lure a rodent into the interior of device 100 through openings in device 100 and to more effectively capture the rodent on an adhesive material. For instance, bait may be placed within device 100 to lure a rodent to travel inside. As shown, device 100 includes a base 102 and a lid 104. Lid 104 may be attached to base 102 such that lid 104 is pivotable relative to base 102 between a first, closed position (e.g., FIG. 1) and a second, open position (e.g., FIG. 10) to enable access to the interior volume defined by base 102 and lid 104 when lid 104 is in the first, closed position.

The depicted configuration of lid 104 includes a body 120 from which hooks 206A, 206B, 206C, and 206D extend; and base 102 includes a rod 204 configured to be engaged by hooks 206A, 206B, 206C, and 206D of lid 104 to thereby pivotably attach lid 104 to base 102. In other examples, the base may include the hooks, and the lid may include the rod. In further examples, rod 204 may be split into two separate rods such that a first rod is engaged by hooks 206A and 206B, while a second rod is engaged by hooks 206C and 206D. In some examples, hooks 206A and 206B may be combined into a single hook and/or hooks 206C and 206D may be combined into a single hook. In other examples, hooks 206A, 206B, 206C, and 206D may all be combined into a single hook. In other embodiments, the lid may be pivotably coupled to the base in ways other than that illustrated.

In the depicted embodiment, base 102 includes a sidewall 116 extending from a floor having a floor upper surface 504 and a floor lower surface 506. Sidewall 116 defines an external perimeter of base 102; in this embodiment, sidewall 116 has four sides in a rectangular shape. Other embodiment may have any suitable shape and any suitable number of sides. Body 120 of lid 104 may have any suitable shape that matches the shape of sidewall 116 of base 102 in order to define the interior volume of device 100.

The device (e.g., the base and/or the lid) defines one or more openings configured to allow a rodent to access an interior of the device. For example, in the embodiment shown, sidewall 116 of base 102 defines two openings 106, 200. Each opening 106 is shaped and sized to allow a rodent to pass through opening 106 and thereby access the interior of device 100.

In the illustrated example of this embodiment, opening 106 is opposite opening 200. For instance, each of opening 106 and opening 200 are in the shorter sides of the rectangular shape of sidewall 116. In other examples, base 102 may have a different suitable arrangement of the openings 106 and 200. In other examples still, the sidewall 116 of base 102 may include three or more openings. For example, sidewall 116 may have a square shape with an opening similar to openings 106 and 200 in each of the sides of sidewall 116.

The lid of the device includes one or more ramps that increase the likelihood of trapping a rodent within the device. Including the ramp(s) with the lid also enables unobstructed access to the interior of the device when the lid is pivoted to the open position. The lid typically includes a number of ramps equal to the number of rodent access openings of base 102, and the ramps are arranged so as to align with the rodent access openings. For example, in the embodiment shown, lid 104 includes a ramp 108 and a ramp 202. When lid 104 is in the closed position, ramp 108 is aligned with opening 106 and ramp 202 is aligned with opening 200. Ramps 108 and 202 increase the likelihood of trapping a lured rodent onto adhesive material 500 disposed within device 100. For instance, when a rodent travels up and over ramp 108 or 202, the rodent has no choice but to travel (e.g., fall) onto the sticky, adhesive side of adhesive material 500. The rodent is unlikely to be able to reverse course after traveling over ramp 108 or 202 given that gravity will pull the rodent down onto adhesive material 500. Stated differently, ramps 108 and 202 cause the rodent to commit to traveling onto adhesive material 500 and becoming trapped. Additionally, it is more likely that a rodent traveling over ramp 108 or 202 will have a significant portion of the rodent's body contact adhesive material 500 as compared to a rodent traveling up to a typical glue trap on a flat surface, which makes it less likely that the rodent can escape from adhesive material 500. In this way, device 100 can be a more effective pest capture device than typical pest capture devices.

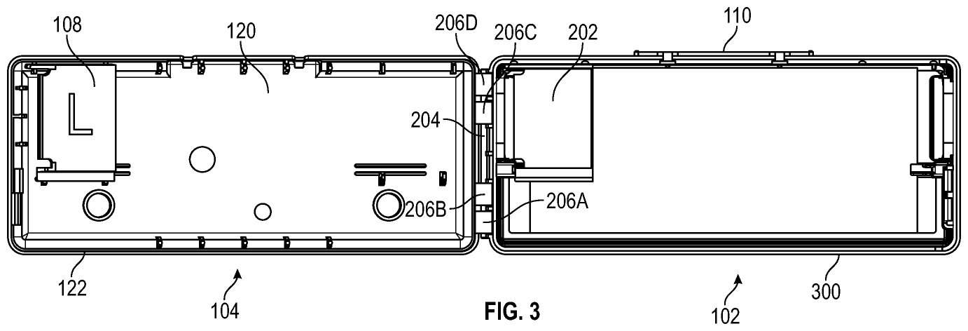

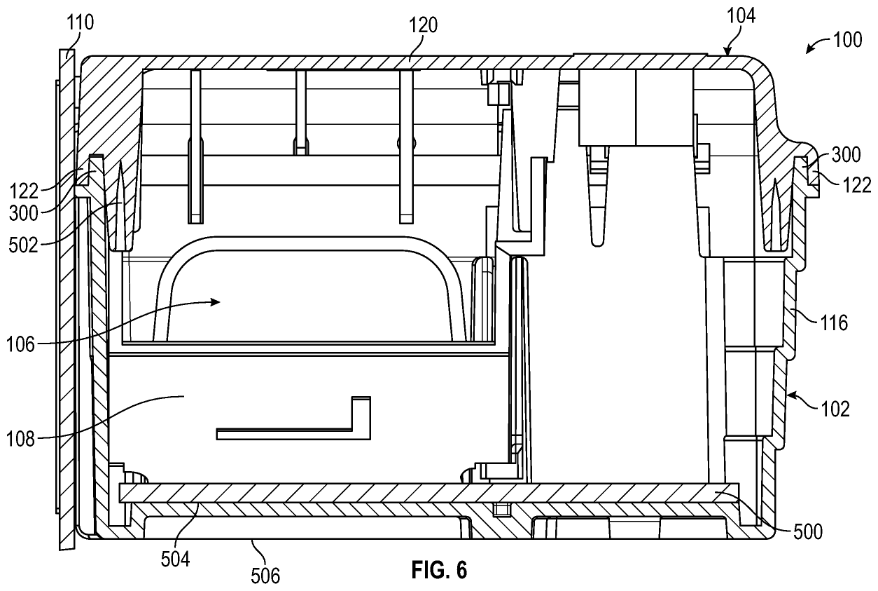

Additionally, ramps 108 and 202 being included with lid 104 can facilitate an easier replacement of a used adhesive material 500 (e.g., an adhesive material 500 with a dead rodent or an old or contaminated adhesive material 500). For example, lid 104 in the closed position can be pivoted away from base 102 to the open position in order to expose the interior volume of device 100. When lid 104 is pivoted to the open position, the ramps 106 and 202 travel with lid 104, and therefore do not obstruct access to the used adhesive material 500. One therefore has direct access to remove the used adhesive material 500 and to then place a new adhesive material 500. Ramps 106 and 202 are shown in different positions throughout the figures for illustrative purposes. For instance, despite being coupled to lid 104 in operation, FIG. 3 shows ramp 202 removed from lid 104 and disposed in base 102 with lid 104 in the open position to illustrate how ramp 202 fits into base 102. FIG. 3 shows a top side of ramp 202 and an underside of ramp 108. Additionally, the cross-section of FIG. 6 shows an underside of ramp 108 given the incline of ramp 108.

Ramps 108 and 202 are attached to, or formed integrally with, body 120 of lid 104. For example, in the depicted embodiment, ramp 108 is part of a ramp structure 708 that is attached to body 120 of lid 104. The ramp structure 708 includes a wall 714 on a first side of ramp 108 and a wall 716 on a second, opposite side of ramp 108. Each of walls 714 and 716 may be attached to (e.g., screws, adhesive, etc.) or formed integrally with body 120 of lid 104. Ramp 202 is part of a ramp structure 706 that is attached to body 120 of lid 104. The ramp structure 706 includes a wall 710 on a first side of ramp 202 and a wall 712 on a second, opposite side of ramp 202. Each of the walls 710 and 712 are attached to (e.g., screws, adhesive, etc.) body 120 of lid 104, though may be formed integrally with body 120 in other embodiments.

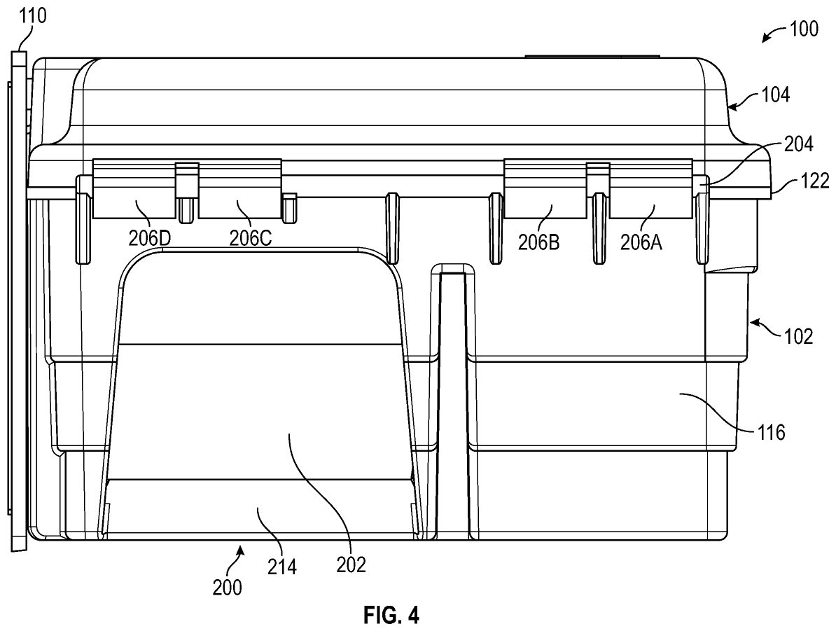

When lid 104 is in the closed position, ramp 108 is adjacent opening 106 of base 102 (as shown best in FIG. 1) and ramp 202 is adjacent opening 200 of base 102 (as shown best in FIG. 4) such that when a rodent travels through opening 106 or 200, the rodent travels up ramp 108 or 202. Ramps 108 and 202 may be at a suitable angle (e.g., within a range of 15° to 45°) relative to the floor lower surface 506 for a rodent to travel up ramps 108 and 202. For example, ramp 108 may be angled such that a plane including the entirety of ramp 108 intersects lid 104. In the depicted embodiment, ramp 202 is on an opposite side of device 100 as ramp 108. In other embodiments, ramp 108 and ramp 202 may be disposed on sides of device 100 that are not opposite each other.

As stated above, adhesive material 500 may be positioned within the interior defined by base 102 and lid 104. For instance, the adhesive material 500 may be placed on the floor upper surface 504 such that a sticky, adhesive side is facing towards lid 104. The side of the adhesive material 500 facing the floor upper surface 504 may be adhesive so as to maintain a position of the adhesive material relative to the floor upper surface 504, or may be non-adhesive. In one example, a plastic or cardboard tray may support the adhesive material 500. The adhesive material 500 may be any suitable adhesive material (e.g., materials used in typical “glue traps”) for holding rodents when they come in contact with the adhesive material 500. In some aspects, the adhesive material 500 may have a cut-out for the at least one opening 724A, 724B in the floor of base 102, as shown in FIG. 10.

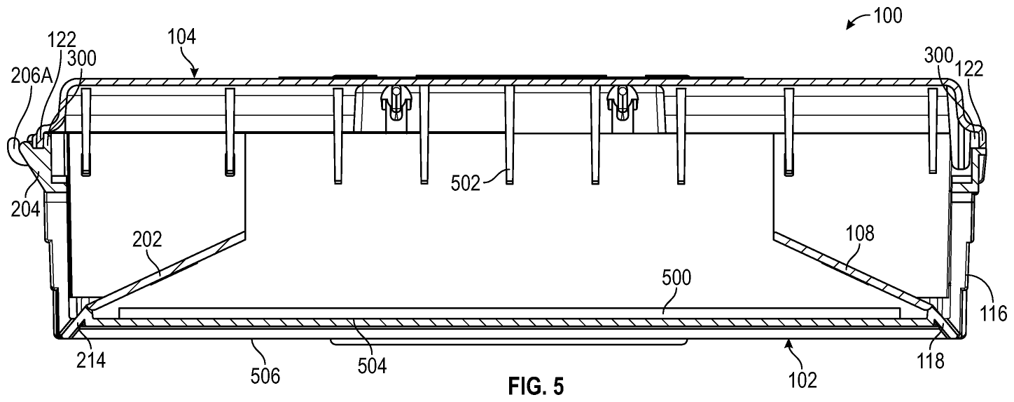

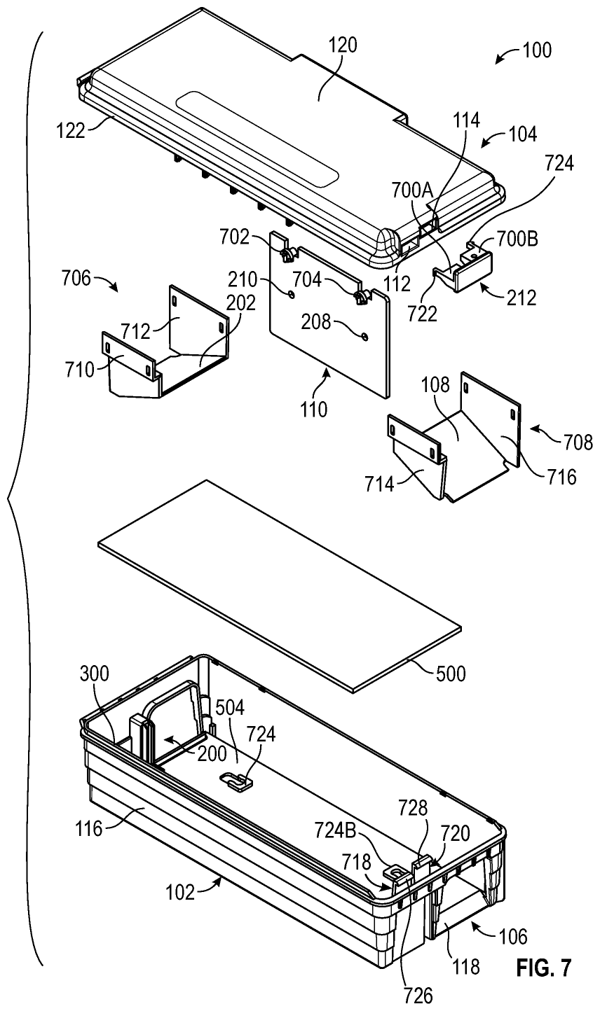

In the depicted embodiment, lid 104 includes a lip 122 (as best illustrated in FIG. 10 and the cross sections of FIGS. 5 and 6) and base 102 includes a lip 300 (as best illustrated in FIGS. 7-10). When lid 104 is in the closed position, lip 122 of lid 104 surrounds lip 300 of base 102 to maintain alignment of lid 104 relative to base 102. In at least some aspects, lid 104 may include multiple protrusions 502 extending from body 120. For example, FIG. 10 of the illustrated embodiment shows protrusions 502 on three sides of lid 104, though only one protrusion is indicated with a reference numeral to maintain clarity in the figure. Protrusions 502 may be arranged such that, when lid 104 is in the closed position, lip 300 of base 102 is positioned between lip 122 of lid 104 and each of protrusions 502, as best shown in FIG. 6 of the illustrated embodiment. In this arrangement, protrusions 502 help stabilize base 102 relative to lid 104. For instance, protrusions 502 prevent lip 300 of base 102 from flexing inward or outward relative to lip 122 of lid 104. Other suitable configurations to maintain alignment between lid 104 and base 102 are contemplated in other embodiments.

In the depicted embodiment, base 102 includes inclined surfaces 118, 214. As shown, inclined surface 118 may begin at opening 106 and lead into the interior of device 100, and inclined surface 214 may begin at opening 200 and lead into the interior of device 100. Inclined surfaces 118, 214 may be at a suitable angle (e.g., within a range of 20° to 50°) relative to floor lower surface 506. Ramps 108, 202 are inclined at an angle relative to floor lower surface 506 that is different than the angle of inclined surfaces 118, 214 relative to floor lower surface 506 in the illustrated embodiment. In other embodiments, ramps 108, 202 may be inclined at the same angle as inclined surfaces 118, 214 relative to floor lower surface 506. In the depicted embodiment, ramp 108 contacts inclined surface 118, and ramp 202 contacts inclined surface 214, when lid 104 is in the closed position to create a continuous surface (e.g., lack of any gaps) between inclined surfaces 118, 214 and ramps 108, 202. As shown in FIG. 5 of the depicted embodiment, inclined surfaces 118, 214 rise above floor upper surface 504 to create space for adhesive material 500.

The device may include a locking mechanism that maintains the lid in the closed position until the locking mechanism is released. For example, in the depicted implementation of the locking mechanism, base 102 includes a tab 718 and a tab 720. Tab 718 has a protrusion 726. Tab 720 has a protrusion 728. Body 120 of lid 104 has an opening 112 and an opening 114. When lid 104 is pivoted to the closed position, openings 112 and 114 may snap onto tabs 718 and 720 such that protrusion 726 is positioned within opening 112 and protrusion 728 is positioned within opening 114. Stated differently, as lid 104 is pushed onto tabs 718 and 720, tabs 718 and 720 flex towards the interior of device 100 and then rebound back to a resting state such that protrusion 726 is positioned within opening 112 and protrusion 728 is positioned within opening 114. Protrusions 726 and 728 thereby prevent lid 104 from being pivoted away from base 102.

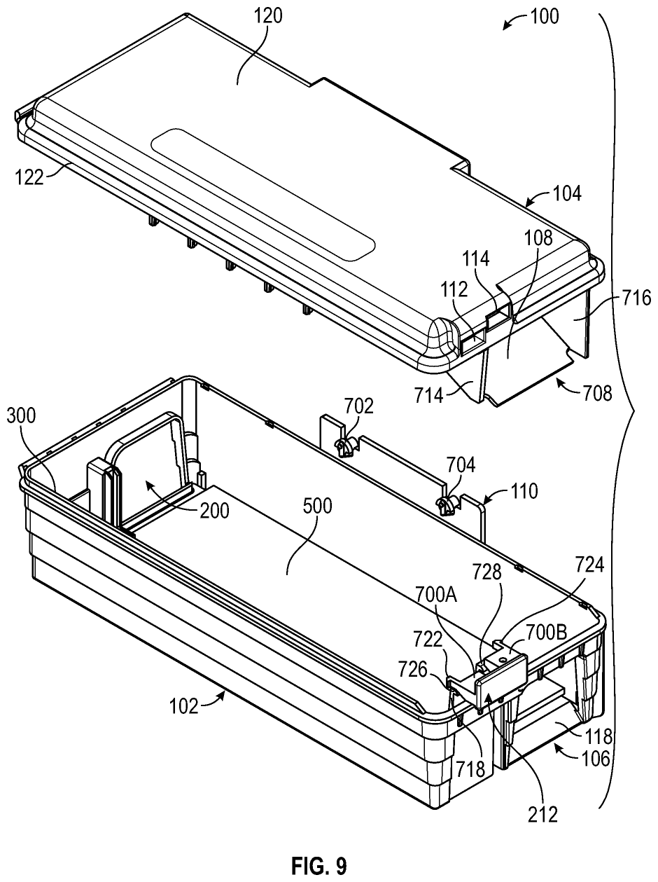

The depicted locking mechanism includes a key 208 for unlocking lid 104. Key 208 includes a tab 700A and a tab 700B. Tab 700A includes a protrusion 722. Tab 700B includes a protrusion 724. To unlock lid 104 from the closed position, tab 700A may be positioned into opening 112 and tab 700B may be positioned into opening 114, and key 208 may be pressed to drive tabs 700A and 700B further into openings 112 and 114. Tabs 700A and 700B push protrusions 726 and 728 of tabs 718 and 720 out of openings 112 and 114, which allows lid 104 to be pivoted away from base 102. FIG. 9 shows key 208 with tabs 700A and 700B contacting protrusions 726 and 728 of tabs 718 and 720 solely to illustrate this contact. It will be appreciated that key 208 will be positioned through openings 112 and 114 in lid 104 when in use.

Key 208 may become attached to lid 104 in some embodiments when lid 104 is unlocked. For example, key 208 may be pressed such that protrusions 722 and 724 exit the interior side of openings 112 and 114 and therefore prevent key 208 from being pulling back out from lid 104. Stated differently, tabs 700A and 700B may flex towards one another as key 208 is pressed into openings 112 and 114, and then snap back to a resting state once protrusions 722 and 724 exit the interior side of openings 112 and 114. To remove key 208 from lid 104, tabs 700A and 700B may be squeezed together and key 208 pulled from openings 112 and 114. Key 208 is a separate component that may be stored for safekeeping, thus making it more difficult to unintentionally open device 100 or for an unintended person (e.g., child) to open device 100.

In some embodiments, the locking mechanism may include only (i) tab 718, opening 112, and tab 700A, or (ii) only tab 720, opening 114, and tab 700B. Embodiments with both (i) and (ii), such as the depicted embodiment, increase security of the locking mechanism (e.g., childproof). For instance, without key 208, two tabs must be pushed in order to release lid 104 rather than just a single tab. The illustrated embodiment may further increase security of the locking mechanism by having tab 718 and tab 720 at different heights, which makes it more difficult for a child to push both tab 718 and tab 720 at the same time.

The device may be mounted to another structure in some embodiments using a suitable mounting mechanism. For example, in the depicted embodiment, device 100 includes a mounting structure 110 for securing device 100 to another structure (e.g., a wall). Mounting structure 110 includes apertures 208 and 210 for receiving a respective attachment member (e.g., a screw). While two apertures 208 and 210 are shown in the illustrated embodiment, in other examples, mounting structure 110 may include a different suitable quantity of apertures. Mounting structure 110 may include mount members 702 and 704 for securing device 100 to mounting structure 110. While two mount members 702 and 704 are shown in the illustrated embodiment, in other examples, mounting structure 110 may include a different suitable quantity of mount members. In the illustrated embodiment, body 120 of lid 104 includes a channel 800 and a channel 802. Channel 800 may receive the mount member 704, and channel 802 may receive mount member 702. In other embodiments, base 102 may include channels 800 and 802.

In an example usage scenario, mounting structure 110 may first be attached to a structure to which device 100 will be secured. For instance, a screw may be inserted through each of apertures 208 and 210 and into the structure. Device 100 with lid 104 in the closed position may then be attached to mounting structure 110. For instance, device 100 may be positioned such that mount members 704 and 702 slide within channels 800 and 802, respectively, of lid 104. Each of mount members 702 and 704 may include a lip such that device 100 is prevented from translating along an axis perpendicular to mounting structure 100.

In certain embodiments, the device may be attached to the ground or other supporting structure. For example, in the depicted embodiment, the floor of base 102 may include at least one opening 724A, 724B for a suitable attachment member (e.g., a screw). For instance, the attachment member may secure base 102 to a surface on which base 102 is positioned so that device 100 does not move in response to forces a rodent may place on device 100.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments. For example, embodiments of the present methods and systems may be practiced and/or implemented using different structural configurations, materials, ionically conductive media, monitoring methods, and/or control methods.

The claims are not intended to include, and should not be interpreted to include, means-plus- or step-plus-function limitations, unless such a limitation is explicitly recited in a given claim using the phrase(s) “means for” or “step for,” respectively.

1. A pest capture device, comprising:
a base including an opening; and
a lid attached to the base and pivotable between a first position and a second position, the lid including a ramp,
wherein when the lid is in the first position: (i) the base and the lid define an interior volume and (ii) the ramp is adjacent the opening of the base.

2. The pest capture device of claim 1, wherein a plane including the ramp intersects the lid.

3. The pest capture device of claim 1, wherein the ramp is attached to the lid.

4. The pest capture device of claim 1, wherein the ramp is integral with the lid.

5. The pest capture device of claim 1, wherein the ramp is included in a ramp structure, the ramp structure including a first wall on a first side of the ramp and a second wall on a second side of the ramp, wherein the first and second walls are attached to, or integral with, the lid.

6. The pest capture device of claim 1, wherein the base includes an inclined surface, and wherein the inclined surface contacts the ramp when the lid is in the first position.

7. The pest capture device of claim 6, wherein the inclined surface has a different inclination angle than the ramp relative to a bottom of the base.

8. The pest capture device of claim 1, further comprising a mounting structure configured to mount the pest capture device to another structure.

9. The pest capture device of claim 1, wherein the opening is a first opening, the base further including a second opening, wherein the ramp is a first ramp, the lid further including a second ramp.

10. The pest capture device of claim 9, wherein a first plane including the first ramp intersects a second plane including the second ramp.

11. The pest capture device of claim 9, wherein the second ramp is adjacent the second opening of the base when the lid is in the closed position.

12. The pest capture device of claim 11, wherein the first opening is opposite the second opening.

13. The pest capture device of claim 1, further comprising an adhesive material positioned within the enclosed volume.

14. A pest capture device, comprising:
a base including a plurality of sides and a floor, wherein a first side of the base includes a first opening and a second side of the base includes a second opening;
a lid including a first ramp and a second ramp,
wherein the first ramp includes a first end opposite a second end, wherein the first end is adjacent the first opening of the base, wherein the second end is spaced from the first opening of the base, and wherein the second end is spaced farther from the bottom of the base than the first end,
wherein the second ramp includes a third end opposite a fourth end, wherein the third end is adjacent the second opening of the base, wherein the fourth end is spaced from the second opening of the base, and wherein the fourth end is spaced farther from the bottom of the base than the third end, and
wherein the lid is pivotably attached to the base; and
an adhesive material positioned between the floor of the base and the lid.

15. The pest capture device of claim 14, wherein the lid is pivotable between a first position and a second position, the pest capture device further comprising a locking mechanism configured to maintain the lid in the first position.

16. The pest capture device of claim 14, wherein the base includes four sides, wherein the first and second sides of the base have shorter lengths than third and fourth sides of the base.

17. The pest capture device of claim 14, wherein the first ramp is at an angle relative to the bottom of the base within a range of 15 to 45 degrees.

18. The pest capture device of claim 14, wherein the base includes a rod, wherein the lid includes a hook, and wherein the lid is pivotably attached to the base via the hook and the rod.

19. A method for replacing an adhesive plate within an interior volume of a pest capture device, the pest capture device including a base and a lid, the base including an opening, the lid including a ramp, and wherein the ramp is adjacent the opening of the base when the lid is in a first position, the method comprising:
pivoting the lid from the first position to a second position thereby exposing the interior volume of the pest capture device;
removing the adhesive plate from the interior volume; and
inserting a new adhesive plate into the interior volume.

20. The method of claim 19, further comprising unlocking a locking mechanism prior to pivoting the lid from the first position to the second position.
